(19) United States
(12) Patent Application Publication
(10) Pub. No.: US 2005/0078615 A1
(43) Pub. Date: Apr. 14, 2005

(54) Method and device for duplex communication

(76) Inventor: David L. Muri, Sunrise, FL (US)

Correspondence Address: MOTOROLA, INC., 1303 EAST ALGONQUIN ROAD, IL01/3RD, SCHAUMBURG, IL, 60196, US

(21) Appl. No.: 10/684,642

(22) Filed: Oct. 14, 2003

(51) Int. Cl. H04B 7/00

(52) U.S. Cl. 370/277

(57) ABSTRACT

A communication device (100) for duplex communication that includes: a transmitter (106) for transmitting a first voice signal encoded at a first voice coding rate and including first voice data, first error correction data having a first error correction rate and first control data; a receiver (108) for receiving a second signal having a first signal quality and including second control data; and a processing device (118) adapted for performing an algorithm for, estimating the first signal quality, operating in a first mode of operation when the signal quality estimation is above a threshold, wherein the first voice coding rate is adjusted as a function of the first and second control data, and operating in a second mode of operation when the signal quality estimation is below the threshold, wherein the first error correction rate is adjusted as a function of the first and second control data.

### FIELD OF THE INVENTION

The present invention relates generally to communication devices and more specifically to communication devices operating in a duplex mode.

### BACKGROUND OF THE INVENTION

As communication devices continue to receive more widespread acceptance, and as various new uses for communication devices emerge, the need for more spectrally efficient communication becomes evident. One such area, wherein spectrum efficiency may be enhanced is in the area of duplex communications.

Full duplex operation is desired because it is the ultimate in communication and it is available in telephonic communication. For instance, in a Frequency Division Multiple Access (FDMA) system, a duplex call is typically made between two participants or users in the system. In this mode of operation, the participants transmit and receive signals at the same time without having to take turns as in a simplex call.

In a Time Division Multiple Access (TDMA) system, a duplex call is typically made between two participants or users in the system. In this mode of operation, the two participants transmit to each other in differing slots of time, such that they seemingly transmit and receive signals at the same time without having to take turns in talking to each other as in a simplex call.

One way in which spectrum utilization has been improved is through the use of a time assigned variable rate voice coding scheme. In this method of operation, two communication devices may communicate with each other using various information coding rates that are allowed to dynamically vary as the demand for transmission by each party varies to accomplish duplex operation on a single narrow band communication channel. Specifically, by detecting requests for transmission, the originating communication device reduces its voice coding rate. Since the modulation rate remains the same, the reduced coded voice signal takes less time to transmit. This frees up time for the second communication device to transmit its information. The transmission by the second communication device takes place during a receive period at a reduced information coding rate. This is the second portion of the transmit/receive cycle. The second communication device further increases its voice coding rate when the first device has no information to transmit. The dynamic adjustment of voice coding rates allows the two devices to communicate with each other in a perceived full duplex mode while reducing the required spectrum. This variable voice coding scheme works well when signal quality is high, but will degrade when signal quality falls below a certain threshold.

Thus, there exists a need for a device and method for extending the range in which communication devices may operate in a duplex mode by enabling the devices to continue to operate at reduced signal strengths.

### BRIEF DESCRIPTION OF THE FIGURES

A preferred embodiment of the invention is now described, by way of example only, with reference to the accompanying figures in which:

FIG. 1 illustrates a simple block diagram of a communication device in accordance with an embodiment of the present invention;

FIG. 2 illustrates a simple block diagram of a communication system have two communication devices, in accordance with an embodiment of the present invention;

FIG. 3 illustrates a timing diagram of a sample operation of the communication devices of FIG. 2, in accordance with an embodiment of the present invention;

FIG. 4 illustrates a timing diagram of a sample operation of the communication devices of FIG. 2, in accordance with an embodiment of the present invention;

FIG. 5 illustrates a timing diagram of a sample operation of the communication devices of FIG. 2, in accordance with an embodiment of the present invention;

FIG. 6 illustrates a timing diagram of a sample operation of the communication devices of FIG. 2, in accordance with an embodiment of the present invention;

FIG. 7 illustrates a timing diagram of a sample operation of the communication devices of FIG. 2, in accordance with an embodiment of the present invention;

FIG. 8 illustrates a timing diagram of a sample operation of the communication devices of FIG. 2, in accordance with an embodiment of the present invention;

FIG. 9 illustrates a timing diagram of a sample operation of the communication devices of FIG. 2, in accordance with an embodiment of the present invention; and

FIG. 10 illustrates a timing diagram of a sample operation of the communication devices of FIG. 2, in accordance with an embodiment of the present invention.

### DETAILED DESCRIPTION OF THE PREFERRED EMBODIMENT

While this invention is susceptible of embodiments in many different forms, there are shown in the figures and will herein be described in detail specific embodiments, with the understanding that the present disclosure is to be considered as an example of the principles of the invention and not intended to limit the invention to the specific embodiments shown and described. Further, the terms and words used herein are not to be considered limiting, but rather merely descriptive. It will also be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate corresponding elements.

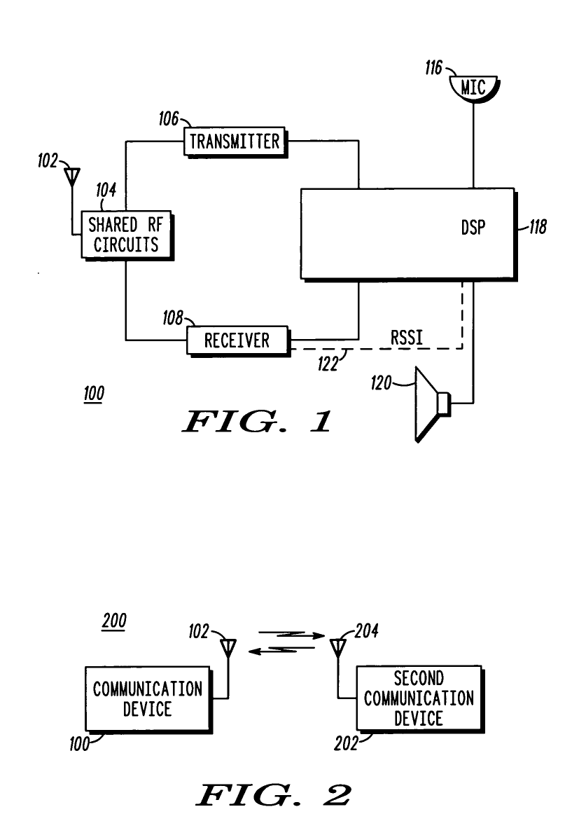

FIG. 1 illustrates a simple block diagram of a communication device 100 in accordance with an embodiment of the present invention. Communication device 100 is adapted for transmitting and receiving information signals that are typically voice signals, but may transmit and receive other types of data information such as, for instance, file transfers, data messaging, etc. Device 100 includes an antenna 102, shared RF circuits 104, a transmitter 106, a receiver 108, a digital signal processor (“DSP”) 118, a microphone 116, a speaker 120, and a voice coder (not shown), wherein the voice coder is typically implemented in a software algorithm in a processing unit such as, for instance, the DSP of the communication device 100. However, it is also appreciated that the voice coder may also be implemented in hardware. Moreover, it is also appreciated that a controller device for controlling the transmitter and receiver is incorporated within communication device 100. This controller device may be separately incorporated into each of the receiver and transmitter, may be part of the shared circuitry 104, may be a separate controller device, or may be incorporated into the DSP.

In operation, antenna 102 is used to receive and transmit voice signals. During a transmit mode, the communications device 100 receives an original voice signal or waveform into its microphone 116, wherein the voice coder encodes the original voice signal using conventional means such as, for instance, VSELP (vector sum excited linear prediction), AMBE (advanced multi-band excitation), LPC (linear predictive coding), and IMBE (improved multi-band excitation), to generate an encoded voice signal that is then transmitted by the transmitter 106 to another communications device via the antenna 102. The rate at which the original voice signal is encoded is defined as a voice coding rate. Moreover, a Forward Error Correction (FEC) or any other suitable error correction methodology may be used to add error correction bits to the encoded voice signal. The number of error correction bits added to a given encoded voice signal defines an error correction or FEC rate for the encoded signal, wherein a higher FEC rate indicates a larger number of error correction bits being added, and a lower FEC rate indicates a lower number of error correction bits being added. FEC is also typically performed in software in the DSP. The voice coder is also adapted for detecting the level or strength of speech in a voice signal to be transmitted or received, for instance, through the use of a voice activity detector (“VAD”) or any other suitable voice activity level detection means, wherein a higher VAD number indicates a higher confidence in the presence of speech and a lower VAD number indicates a lower confidence in the presence of speech. The voice coder is, therefore, accordingly adapted to generate a voice activity level signal that corresponds to its voice signal being transmitted so that the communication device 100 may transmit its voice activity level information to another communication device along with its voice signal.

During a receive mode, the receiver 108 of the communications device 100 receives, via the antenna 102, an encoded voice signal that is based on an original voice signal spoken into a different communication device. This received encoded signal is then decoded in the voice coder, using conventional means such as, for instance, VSELP, AMBE, LPC and IMBE, to recover at least a portion of the original voice signal spoken into the other communication device. The decoded voice is then coupled to speaker 120 for the user of device 100 to hear.

Communication device 100 is also adapted for determining the strength of a received signal, using one of a number of conventional means to estimate signal quality, and for comparing this signal quality estimation (“SQE”) to an SQE threshold. For instance, the DSP 118 may estimate signal quality of received signals in software as a function of one or more of the following exemplary factors: an externally calculated received signal strength indicator (“RSSI”), e.g., an RSSI calculated in the receiver 108 and coupled to the DSP, as indicated by the dashed line 122 in FIG. 1; an internally calculated RSSI, i.e., an RSSI calculated in software in the DSP; and a bit error rate calculation, wherein the DSP 118 determines the number of errors not being corrected in the received signal. Moreover, the SQE threshold may be predetermined and stored in a memory means in communication device 100 that is accessible by the DSP. Alternatively, the SQE threshold may be dynamically determined, for instance in the DSP, based on a history of one or more of the following factors: the externally calculated RSSI, the internally calculated RSSI, and the bit error rate calculation. It is further understood that the SQE and the SQE threshold may be based on other factors and signal strength estimations known in the art.

The functionality of communication device 100 discussed above is not all-inclusive. Thus, it is appreciated that device 100 typically performs additional conventional processing functions such as, for instance, synchronization of a received voice signal typically through utilization of synchronization data received with the voice signal, modulation, interleaving, etc.

FIG. 2 illustrates a simple block diagram of a communication system 200 in accordance with an embodiment of the present invention. System 200 includes the communication device 100 and its associated antenna 102 and a second communication device 202 and its associated antenna 204. The components of the communication device 202 are similar to those of communication device 100. System 200 is illustrated as having only two communication devices. However it is appreciated that a communication system typically has a multiplicity of communication devices and typically also includes additional devices such as repeaters, routers, etc.

The operation of communication device 100, and the method by which duplex communication is accomplished between devices 100 and 202, is better understood by reference to the timing diagrams of FIGS. 3-10. These timing diagrams demonstrate the allocation of time to the communication devices 100 and 202 on a single channel in order to provide duplex operation in one of two alternative modes of operation. Each figure includes a timing diagram associated with a user 1 of communication device 100 and a diagram associated with a user 2 of communication device 202. The timing diagrams shown in FIGS. 3-10 include a sample period or frame 302 that is repeated in time. Accordingly, FIGS. 3-6 illustrate a complete cycle during which communication devices 100 and 202 transmit voice signals to each other and receive voice signals from each other on a single channel in a first mode of duplex operation, wherein signal quality is high, e.g., the SQE is above the SQE threshold. FIGS. 7-10, alternatively, illustrate a complete cycle during which communication devices 100 and 202 transmit voice signals to each other and receive voice signals from each other on a single channel in a second mode of duplex operation wherein, signal quality is low, e.g., the SQE is below the SQE threshold.

Referring to FIG. 3, the timing diagrams for user 1 and user 2 illustrate a state wherein user 1 is talking, i.e. communication device 100 is transmitting a voice signal, and user 2 is quiet or listening, i.e., communication device 202 is not transmitting a voice signal. The voice signal transmitted from communication device 100 to communication device 202 includes voice data 304 that was encoded at an increased voice coding rate that is typically a maximum voice coding rate for the device's voice coder, which in this example is 4 Kbps but may different based upon the capabilities of the voice coder. The transmitted voice signal further includes FEC data or bits 306 typically having a predetermined FEC rate, and control data 308 having control information that may include, for instance, the voice coding rate for the transmitted voice signal, voice activity level information associated with the transmitted voice signal, e.g., a VAD signal that indicates to communication device 202 the confidence in the presence of the transmitted voice signal, or other control information as needed such as, for instance, synchronization information. Following the transmission of its voice signal, the transmitter 106 releases the channel for a period 310. This time period 310 is reserved for communication device 202 to transmit its signal that comprises control data 312 that may include, for instance, one or more of the following types of control information, a request for a certain portion of the time period 302 for transmitting a voice signal, a request-to-transmit voice data, and a VAD signal that indicates to communication device 100 the confidence in the presence of the voice signal to be received by communication device 100.

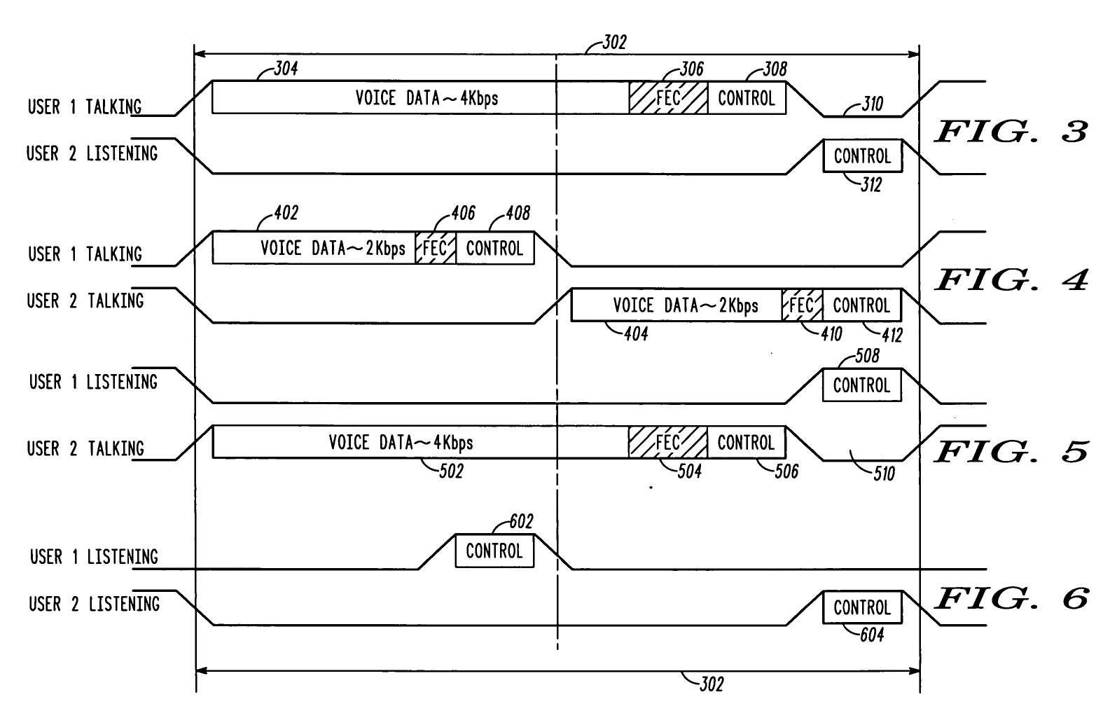

Referring to FIG. 4, the timing diagrams for user 1 and user 2 illustrate a state wherein both communication devices 100 and 202 are transmitting a voice signal. The transition from the state illustrated in FIG. 3 to the state illustrated in FIG. 4 is typically accomplished via handshaking between communication device 100 and communication device 202, wherein a voice coding rate for the voice coders in each communication device is agreed upon, which determines the amount of time during the time period 302 each of the devices will be transmitting. Handshaking between the two devices may be accomplished using one of a number of methods including, but not limited to: communication device 100 detecting from the control data 312 the VAD information indicating a high confidence in the presence of speech to be received by the receiver 108, and in addition, detecting a request-to-transmit from communication device 202, wherein communication device 100 acknowledges the VAD information and the request to transmit and both communication devices transmit their respective voice signals at a reduced voice coding rate.

Accordingly, the voice signal transmitted from communication device 100 to communication device 202 includes voice data 402 that was encoded at a first reduced voice coding rate, FEC data 406, and control data 408. The voice signal transmitted from communication device 202 to communication device 100 includes voice data 404 that was encoded at a second reduced voice coding rate, FEC data 410, and control data 412. Typically, the first and second reduced voice coding rates are essentially the same and may be, for instance, 2 Kbps. However, it is appreciated by those of ordinary skill in the art that the first and second reduced voice coding rates may not be the same, and these rates are based on a design choice that may be governed by other system parameters and requirements.

Referring to FIG. 5, the timing diagrams for user 1 and user 2 illustrate a state wherein communication device 100 is not transmitting a voice signal and communication device 202 is transmitting a voice signal. The transition from the state illustrated in FIG. 4 to the state illustrated in FIG. 5 is typically accomplished via handshaking between communication device 100 and communication device 202, wherein a voice coding rate for the voice coders in each communication device is agreed upon, which determines the amount of time during the time period 302 each of the devices will be transmitting. Handshaking between the two devices may be accomplished using one of a number of methods including, but not limited to: communication device 202 detecting from the control data received from communication device 100 a low VAD number indicating a lower confidence in the presence of speech, and as a result communication device 202 requesting to use a maximum amount of period 302 to transmit its signal and wherein communication device 100 acknowledges and communication device 202 transmits its voice signal at the maximum voice coding rate.

Accordingly, the voice signal transmitted from communication device 202 to communication device 100 includes voice data 502 that was encoded at the maximum voice coding rate, FEC data 504, and control data 506. Following the transmission of its voice signal, the transmitter of communication device 202 releases the channel for a period 510. This time period 510 is reserved for communication device 100 to transmit its signal that comprises control data 508.

Referring to FIG. 6, the timing diagrams for user 1 and user 2 illustrate a state wherein neither communication device 100 nor communication device 202 is transmitting a voice signal. The transition from the state illustrated in FIG. 5 to the state illustrated in FIG. 6 is typically accomplished via handshaking between communication device 100 and communication device 202, wherein the communications devices agree that no voice signals are being transmitted. This typically involves a detection of a low confidence in the presence of speech being transmitted from both of the devices, typically through the mutual transmission of low VAD numbers by each device. In this state, both communication device 100 and communication device 202 typically only transmit their respective signals comprising control data 602 and 604.

Thereafter, either or both of communication devices 100 and 202 may initiate a change in the transmission state via their control data (602, 604). Moreover, it is understood that the state transitions illustrated by reference to FIGS. 3-6 are exemplary of state transitions that may occur. Communication devices 100 and 202 may, thus, dynamically transition between any of the above-described states in any order, as a function of the change in demand by the respective devices for at least a portion of period 302 to transmit their respective voice signals.

In the mode of duplex operation illustrated by reference to FIGS. 3-6, the voice coder rate was dynamically varied to achieve duplex operation between communication devices 100 and 202 on a single channel. The FEC rate, however, was always kept constant or essentially constant in that embodiment. In the alternative mode of duplex operation illustrated by reference to FIGS. 7-10, the voice coder rate is always kept constant or essentially constant, but the FEC rate is dynamically varied to achieve duplex operation between communication devices 100 and 202 on a single channel. This mode is used when signal quality is low, e.g., when the SQE falls below the SQE threshold. By operating in this mode of duplex operation, the communication devices may extend their range of communication.

Referring to FIG. 7, the timing diagrams for user 1 and user 2 illustrate a state wherein communication device 100 is transmitting a voice signal, and communication device 202 is not transmitting a voice signal. The voice signal transmitted from communication device 100 to communication device 202 includes voice data 702 that was encoded at a reduced voice coding rate, which in this case is 2 Kbps but may be different based upon the capabilities of the device's voice coder. The transmitted voice signal further includes FEC data or bits 704 having a suitably higher FEC rate than the predetermined FEC rate used in the duplex operation of the devices in accordance with the timing diagrams of FIGS. 3-6. The higher FEC rate is typically a maximum FEC rate for the voice coder for better protecting the voice data during transmission and for enabling the best quality signal to be recovered in the receiving device. The ability to recover the lower quality voice signal (by virtue of the reduced voice coding rate) is, thereby, enhanced by the use of a higher FEC rate.

The transmitted voice signal further includes control data 706 having control information that may include, for instance, the voice coding rate for the transmitted voice signal, voice activity level information associated with the transmitted voice signal, e.g., a VAD signal that indicates to communication device 202 the confidence in the presence of the transmitted voice signal, or other control information as needed such as, for instance, synchronization information. Following the transmission of its voice signal, the transmitter 106 releases the channel for a period 708. This time period 708 is reserved for communication device 202 to transmit its signal that comprises control data 710 that may include, for instance, one or more of the following types of control information, a request for a certain portion of the time period 302 for transmitting a voice signal, a request-to-transmit voice data, and a VAD signal that indicates to communication device 100 the confidence in the presence of the voice signal to be received by communication device 100.

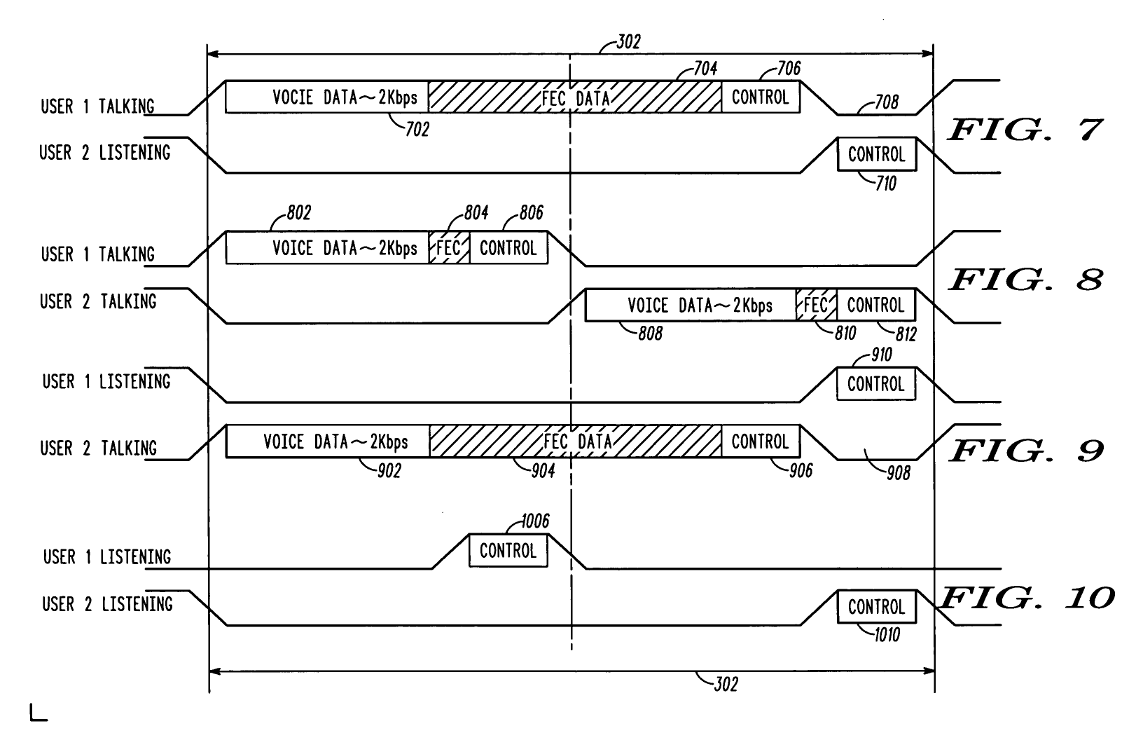

Referring to FIG. 8, the timing diagrams for user 1 and user 2 illustrate a state wherein both communication devices 100 and 202 are transmitting a voice signal. The transition from the state illustrated in FIG. 7 to the state illustrated in FIG. 8 is typically accomplished via handshaking between communication device 100 and communication device 202, wherein an FEC rate for the voice coders in each communication device is agreed upon, which determines the number of error correction bits that will be added to the voice signals that each of the devices will be transmitting. Handshaking between the two devices may be accomplished using one of a number of methods including, but not limited to: communication device 100 detecting from the control data 812 the VAD information indicating a high confidence in the presence of speech to be received by the receiver 108, and in addition, detecting a request-to-transmit from communication device 202, wherein communication device 100 acknowledges the VAD information and the request-to-transmit and both communication devices transmit their respective voice signals at the reduced voice coding rate and using FEC data having a reduced FEC rate.

Accordingly, the voice signal transmitted from communication device 100 to communication device 202 includes voice data 802 that was encoded at the reduced voice coding rate, FEC data 804 having a first reduced FEC rate, and control data 806. The voice signal transmitted from communication device 202 to communication device 100 includes voice data 808 that was encoded at the reduced voice coding rate, FEC data 810 having a second reduced FEC rate, and control data 812. Typically, the first and second reduced FEC rates are essentially the same and may be, for instance, essentially the same as the fixed FEC rate used to transmit voice signals in accordance with the duplex mode of communication illustrated by reference to FIGS. 3-6. However, it is appreciated by those of ordinary skill in the art that the first and second reduced FEC rates may not be the same, and is based on a design choice that may be governed by other system parameters and requirements.

Referring to FIG. 9, the timing diagrams for user 1 and user 2 illustrate a state wherein communication device 100 is not transmitting a voice signal and communication device 202 is transmitting a voice signal. The transition from the state illustrated in FIG. 8 to the state illustrated in FIG. 9 is typically accomplished via handshaking between communication device 100 and communication device 202, wherein an FEC rate for the voice coders in each communication device is agreed upon, which determines the number of error correction bits that will be added to the voice signals that each of the devices will be transmitting. Handshaking between the two devices may be accomplished using one of a number of methods including, but not limited to: communication device 202 detecting from the control data received from communication device 100 a low VAD number indicating a lower confidence in the presence of speech, and as a result communication device 202 requesting to use the maximum FEC rate to encode its transmitted signal and wherein communication device 100 acknowledges and communication device 202 transmits its voice signal at the maximum FEC rate.

Accordingly, the voice signal transmitted from communication device 202 to communication device 100 includes voice data 902 that was encoded at the reduced voice coding rate, FEC data 904 having the maximum FEC rate, and control data 906. Following the transmission of its voice signal, the transmitter of communication device 202 releases the channel for a period 908. This time period 908 is reserved for communication device 100 to transmit its signal that comprises control data 910. The ability to recover the lower quality voice signal (by virtue of the reduced voice coding rate) is, thereby, enhanced by the use of a higher FEC rate.

Referring to FIG. 10, the timing diagrams for user 1 and user 2 illustrate a state wherein neither communication device 100 nor communication device 202 is transmitting a voice signal. The transition from the state illustrated in FIG. 9 to the state illustrated in FIG. 10 is typically accomplished via handshaking between communication device 100 and communication device 202, wherein the communications devices agree that no voice signals are being transmitted. This typically involves a detection of a low confidence in the presence of speech being transmitted from both of the devices, typically through the mutual transmission of low VAD numbers by each device. In this state, both communication device 100 and communication device 202 typically only transmit their respective signals comprising control data 1006 and 1010.

Thereafter, either or both of communication devices 100 and 202 may initiate a change in the transmission state via their control data (1006, 1010). Moreover, it is understood that the state transitions illustrated by reference to FIGS. 7-10 are exemplary of state transitions that may occur and that the communication devices 100 and 202 may dynamically transition between any of the above-described states in any order. Communication devices 100 and 202 may also dynamically transition between the two different modes of operation in accordance with the present invention. Thus, it is appreciated by those of ordinary skill in the art that communication devices 100 and 202 may each be adapted for switching between the two modes of duplex operation, and within each mode of operation, switching between the various states illustrated by reference to FIGS. 3-10. This switching functionality may, for instance, be performed in software in the DSP or may be performed in a controller in each communication device, the controller being implemented as described above. Moreover, duplex communication in accordance with the present invention may be accomplished in any communication system wherein the communication devices may transmit signals on a single frequency such as, for instance, in a TDD (time domain duplex) system.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

1. A communication device for duplex communication comprising:
a transmitter for transmitting, during a first portion of said first period of time, a first voice signal encoded at a first voice coding rate, said first voice signal comprising first voice data, first error correction data having a first error correction rate and first control data;
a receiver for receiving, during a second portion of a first period of time, a second signal having a first signal quality and including at least second control data; and
a processing device coupled to said transmitter and receiver and adapted for performing an algorithm for,
estimating said first signal quality,
causing said communication device to operate in a first mode of operation when said signal quality estimation is above a threshold, wherein said first voice coding rate is adjusted as a function of said first and second control data, and
causing said communication device to operate in a second mode of operation when said signal quality estimation is below said threshold, wherein said first error correction rate is adjusted as a function of said first and second control data.

2. The communication device of claim 1, wherein said processing device is a digital signal processor.

3. The communication device of claim 1, wherein said first control data includes information indicating a first level of confidence in the presence of speech in said first voice signal, and said second control data includes information indicating a second level of confidence in the presence of speech in said second signal.

4. The communication device of claim 3, wherein in said first mode of operation said processing device is further adapted for:
causing said first voice coding rate to be adjusted to an increased voice coding rate when said first level of confidence indicates a high confidence in the presence of speech in said first voice signal and said second level of confidence indicates a low confidence in the presence of speech in said second signal, for enabling said transmitter to transmit, during said first portion of said first time period, said first voice signal encoded at said increased voice coding rate and for enabling said receiver to receive, during said second portion of said first time period, said second signal comprising said second control data, and
causing said first voice coding rate to be adjusted to a first reduced voice coding rate when said first level of confidence indicates a high confidence in the presence of speech in said first voice signal and said second level of confidence indicates a high confidence in the presence of speech in said second signal, for enabling said transmitter to transmit, during said first portion of said first time period, said first voice signal encoded at said first reduced voice coding rate and for enabling said receiver to receive, during said second portion of said first time period, said second signal encoded at a second reduced voice coded rate and comprising at least second voice data and said second control data.

5. The communication device of claim 4, wherein said first and second reduced voice coding rates are essentially the same.

6. The communication device of claim 4, wherein said first error correction rate is caused to remain essentially constant.

7. The communication device of claim 4, wherein said increased voice coding rate is a maximum voice coding rate.

8. The communication device of claim 3, wherein in said second mode of operation said processing device is further adapted for:
causing said first error correction rate to be adjusted to an increased error correction rate when said first level of confidence indicates a high confidence in the presence of speech in said first voice signal and said second level of confidence indicates a low confidence in the presence of speech in said second signal, for enabling said transmitter to transmit, during said first portion of said first time period, said first voice signal including said first error correction data having said increased error correction rate and for enabling said receiver to receive, during said second portion of said first time period, said second signal comprising said second control data, and
causing said first error correction rate to be adjusted to a first reduced error correction rate when said first level of confidence indicates a high confidence in the presence of speech in said first voice signal and said second level of confidence indicates a high confidence in the presence of speech in said second signal, for enabling said transmitter to transmit, during said first portion of said first time period, said first voice signal including said first error correction data having said first reduced error correction rate and for enabling said receiver to receive, during said second portion of said first time period, said second signal comprising at least second voice data, second error correction data having a second reduced error correction rate and said second control data.

9. The communication device of claim 8, wherein said first and second reduced error correction rates are essentially the same.

10. The communication device of claim 8, wherein said first voice coding rate is caused to remain essentially constant.

11. The communication device of claim 8, wherein said increased error correction rate is a maximum error correction rate.

12. The communication device of claim 3, wherein said processing device is further adapted for generating a first voice activity detector number corresponding to said first level of confidence.

13. The communication device of claim 1 further comprising switching means for causing said communication device to switch between said first and second modes of operation.

14. The communication device of claim 13, wherein said switching means is further adapted for causing said first voice coding rate to be switched between an increased voice coding rate and a first reduced voice coding rate during said first mode of operation.

15. The communication device of claim 13, wherein said switching means is further adapted for causing said first error correction rate to be switched between an increased error correction rate and a first reduced error correction rate during said second mode of operation.

16. The communication device of claim 13, wherein said switching means is said digital signal processor.

17. A communication device for duplex communication comprising:
a transmitter for transmitting, during a first portion of a first period of time, a first voice signal encoded at a first voice coding rate, said first voice signal comprising first voice data, first error correction data having a first error correction rate and first control data that includes information indicating a first level of confidence in the presence of speech in said first voice signal;
a receiver for receiving, during a second portion of said first period of time, a second signal having a first signal quality and including at least second control data that includes information indicating a second level of confidence in the presence of speech in said second signal; and
a processing device coupled to said transmitter and receiver and adapted for performing an algorithm for,
estimating said first signal quality,
causing said communication device to operate in a first mode of operation when said signal quality estimation is above a threshold, wherein said processing device is further adapted for,
causing said first voice coding rate to be adjusted to a maximum voice coding rate when said first level of confidence indicates a high confidence in the presence of speech in said first voice signal and said second level of confidence indicates a low confidence in the presence of speech in said second signal, for enabling said transmitter to transmit, during said first portion of said first time period, said first voice signal encoded at said maximum voice coding rate and for enabling said receiver to receive, during said second portion of said first time period, said second signal comprising said second control data, and
causing said first voice coding rate to be adjusted to a first reduced voice coding rate when said first level of confidence indicates a high confidence in the presence of speech in said first voice signal and said second level of confidence indicates a high confidence in the presence of speech in said second signal, for enabling said transmitter to transmit, during said first portion of said first time period, said first voice signal encoded at said first reduced voice coding rate and for enabling said receiver to receive, during said second portion of said first time period, said second signal encoded at a second reduced voice coded rate and comprising at least second voice data and said second control data, and
causing said communication device to operate in a second mode of operation when said signal quality estimation is below said threshold, wherein said processing device is further adapted for,
causing said first error correction rate to be adjusted to a maximum error correction rate when said first level of confidence indicates a high confidence in the presence of speech in said first voice signal and said second level of confidence indicates a low confidence in the presence of speech in said second signal, for enabling said transmitter to transmit, during said first portion of said first time period, said first voice signal including said first error correction data having said maximum error correction rate and for enabling said receiver to receive, during said second portion of said first time period, said second signal comprising said second control data, and
causing said first error correction rate to be adjusted to a first reduced error correction rate when said first level of confidence indicates a high confidence in the presence of speech in said first voice signal and said second level of confidence indicates a high confidence in the presence of speech in said second signal, for enabling said transmitter to transmit, during said first portion of said first time period, said first voice signal including said first error correction data having said first reduced error correction rate and for enabling said receiver to receive, during said second portion of said first time period, said second signal comprising at least second voice data, second error correction data having a second reduced error correction rate and said second control data.

18. A system for duplex communication that includes a communication device in accordance with the communication device of claim 1.

19. A method for duplex communication in a communication device, said method comprising the steps of:
transmitting, during a first portion of a first period of time, a first voice signal encoded at a first voice coding rate, said first voice signal comprising first voice data, first error correction data having a first error correction rate and first control data;
receiving, during a second portion of said first period of time, a second signal having a first signal quality and including at least second control data;
estimating said first signal quality;
causing said communication device to operate in a first mode of operation when said signal quality estimation is above a threshold, wherein said first voice coding rate is adjusted as a function of said first and second control data; and
causing said communication device to operate in a second mode of operation when said signal quality estimation is below said threshold, wherein said first error correction rate is adjusted as a function of said first and second control data.

20. The method of claim 19, wherein said first control data includes information indicating a first level of confidence in the presence of speech in said first voice signal, and said second control data includes information indicating a second level of confidence in the presence of speech in said second signal, and said step of causing said communication device to operate in said first mode of operation further comprises:
causing said first voice coding rate to be adjusted to an increased voice coding rate when said first level of confidence indicates a high confidence in the presence of speech in said first voice signal and said second level of confidence indicates a low confidence in the presence of speech in said second signal, for transmitting during said first portion of said first time period, said first voice signal encoded at said increased voice coding rate and for receiving during said second portion of said first time period, said second signal comprising said second control data; and
causing said first voice coding rate to be adjusted to a first reduced voice coding rate when said first level of confidence indicates a high confidence in the presence of speech in said first voice signal and said second level of confidence indicates a high confidence in the presence of speech in said second signal, for transmitting during said first portion of said first time period, said first voice signal encoded at said first reduced voice coding rate and for receiving during said second portion of said first time period, said second signal encoded at a second reduced voice coded rate and comprising at least second voice data and said second control data.

21. The method of claim 19, wherein said first control data includes information indicating a first level of confidence in the presence of speech in said first voice signal, and said second control data includes information indicating a second level of confidence in the presence of speech in said second signal, and said step of causing said communication device to operate in said second mode of operation further comprises:
causing said first error correction rate to be adjusted to an increased error correction rate when said first level of confidence indicates a high confidence in the presence of speech in said first voice signal and said second level of confidence indicates a low confidence in the presence of speech in said second signal, for transmitting during said first portion of said first time period, said first voice signal including said first error correction data having said increased error correction rate and for receiving during said second portion of said first time period, said second signal comprising said second control data; and
causing said first error correction rate to be adjusted to a first reduced error correction rate when said first level of confidence indicates a high confidence in the presence of speech in said first voice signal and said second level of confidence indicates a high confidence in the presence of speech in said second signal, for transmitting during said first portion of said first time period, said first voice signal including said first error correction data having said first reduced error correction rate and for receiving during said second portion of said first time period, said second signal comprising at least second voice data, second error correction data having a second reduced error correction rate and said second control data.

22. The method of claim 19 further comprising the step of switching between said first and second modes of operation.

23. The method of claim 22 further comprising the step of switching said first voice coding rate between an increased voice coding rate and a first reduced voice coding rate during said first mode of operation.

24. The method of claim 22 further comprising the step of switching said first error correction rate between an increased error correction rate and a first reduced error correction rate during said second mode of operation.
